(19) United States
(12) Patent Application Publication
(10) Pub. No.: US 2011/0184742 A1
(43) Pub. Date: Jul. 28, 2011

(54) METHODS AND APPARATUS FOR INCENTING BEHAVIOR

(75) Inventor: Zachary J. Lynch, San Francisco, CA (US)

(73) Assignee: HEALTHRALLY, San Francisco, CA (US)

(21) Appl. No.: 13/014,538

(22) Filed: Jan. 26, 2011

Related U.S. Application Data
(60) Provisional application No. 61/298,368, filed on Jan. 26, 2010.

(51) Int. Cl. G06Q 99/00

(52) U.S. Cl. 705/1.1

(57) ABSTRACT

The system and method disclosed herein is a social networking platform that enables real-time peer-to-peer positive financial incentives to reward and sustain behavior. The system and method integrates computerized social networking tools, email reminder technologies, workflow and secure financial transaction systems together with compliance metrics to support behavior change through campaigns. The system and method aggregates and pays out money from multiple parties to an individual or multiple individuals for reaching a partial or full behavior-related goal. The campaign may be initiated by one or multiple sponsors or one or multiple leaders. The system and method provides a way for multiple parties to negotiate compliance factors and milestones that determine if the behavior change process is to be considered successful. The system and method displays the earned amount to participants to further solidify the new behavior.

### TECHNICAL FIELD

The present application relates in general to incenting behavior and more specifically to methods and apparatus for incenting behavior using a computerized social network and a reward system.

### BACKGROUND

Existing computerized incentive systems attempt to produce behavior change using a variety of methods including focusing on negative enforcement. For example, a person may be motivated by the possibility of losing money if a goal is not achieved. Some systems provide rewards for making behavioral changes. For example, an employer may provide a reduced insurance rate if an employee quits smoking.

However, these systems do not have any peer-pressure component and thus fail to provide motivation from a person's existing social network. Other systems recognize that people are more motivated when their friends or family are also involved in helping that person make a behavior change. People may be motivated by the loss of a bet made with another individual. For example, a person may make a bet with another person on who will lose the most weight in a given period of time. People may also be motivated to prove to their social network that they can make a behavior change.

However, peer-influenced motivation does not last a long enough time, and people quickly become disinterested in making a behavior change if their peers do not have a constant, verifiable way to ensure that certain behavior changes are actually happening. Because the motivation does not last as long as needed to actually make the behavior change, peer-influenced efforts towards behavior change are short-lived and ineffective.

What is needed is an improved system and method to harness the expansive reach and financial capital of each individual's social network to provide positive incentives in support of behavior change.

### SUMMARY

The system and method disclosed herein is a social networking platform that enables real-time peer-to-peer positive financial incentives to reward and sustain behavior. The system and method integrates computerized social networking tools, email reminder technologies, workflow and secure financial transaction systems together with compliance metrics to support behavior change. The system and method aggregates and pays out money from multiple parties to an individual or multiple individuals for reaching a partial or full behavior-related goal. For example, money from family, friends, co-workers and institutions may provide real-time positive financial rewards to an individual in support of a specific lifestyle change or goal such as quitting smoking, losing weight, improving grades in school, adhering to medication, etc.

In one embodiment, the system and method provides a way for multiple parties to negotiate compliance factors and milestones that determine if the behavior change process is to be considered successful. In one embodiment, the system and method calculates the amount of money per unit of time, e.g., per second or per millisecond, that a participant has earned by following the new behavior. The system and method displays the earned amount to participants to further solidify the new behavior. In one embodiment, the system and method calculates the amount of money pledged by supporters, or sponsors, in terms of the goal itself. For example, if $5,000 has been pledged for a goal of losing twenty pounds, the system and method calculates that the amount pledged is $250 per pound. The system provides a financial reward directly to the successful participant(s) from the pledged money when they reach agreed upon milestones, or compliance factors, or the financial reward can be split up between the respective parties should a participant not meet the compliance metrics or reach the agreed upon goal.

Additional features and advantages are described herein, and will be apparent from the following Detailed Description and the figures.

### BRIEF DESCRIPTION OF THE FIGURES

FIG. 1 is a high level block diagram of an example communications system.

FIG. 2 is a more detailed block diagram showing one example of a computing device.

FIG. 3 is a flowchart showing one example of a sponsor initiated incentive system to influence behavior change.

FIG. 4 is a flowchart showing one example of a leader initiated incentive system to influence behavior change.

FIG. 5 is an example screen illustrating different rewards that a sponsor can select.

FIG. 6 is an example screen illustrating a payment screen.

FIG. 7 is an example screen illustrating a completed payment screen.

FIG. 8 is a screen shot of an example user interface of a page for compliance factor and time frame negotiation.

FIG. 9 is an example goal definition screen.

FIG. 10 illustrates an example screen presented to a leader for selecting supporters.

FIG. 11 illustrates an example screen presented to a leader displaying selected supporters.

FIG. 12 illustrates an example rewards target screen.

FIG. 13 illustrates an example campaign summary screen.

FIG. 14 illustrates an example screen for reviewing supporters.

FIG. 15 is a screen shot of an example mobile user interface displaying an incentive system.

FIGS. 16-29 illustrate additional examples of user interfaces that may be displayed to sponsors and/or leaders.

### DETAILED DESCRIPTION

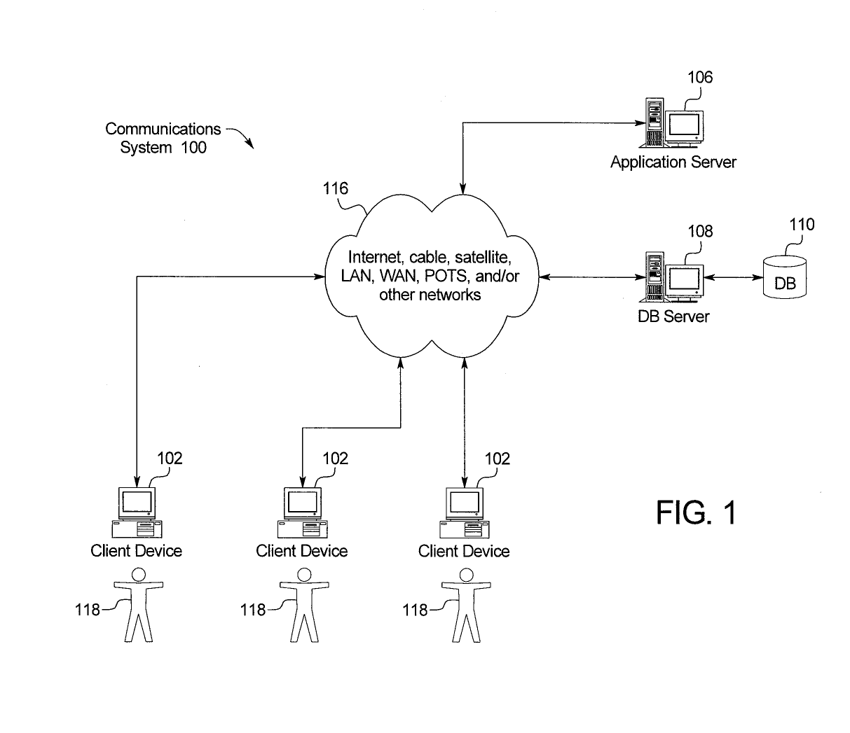

The present system is most readily realized in a network communications system. A high level block diagram of an exemplary network communications system 100 is illustrated in FIG. 1. The illustrated system 100 includes one or more client devices 102, one or more application servers 106 and one or more database servers 108 connected to one or more databases 110. Each of these devices may communicate with each other via a connection to one or more communications channels 116. The communications channels 116 may be any suitable communications channels 116 such as the Internet, cable, satellite, local area network, wide area networks, telephone networks, etc. It will be appreciated that any of the devices described herein may be directly connected to each other and/or connected over one or more networks.

One application server 106 may interact with a large number of client devices 102. Accordingly, each application server 106 is typically a high end computing device with a large storage capacity, one or more fast microprocessors and one or more high speed network connections. Conversely, relative to a typical application server 106, each client device 102 typically includes less storage capacity, less processing power and a slower network connection.

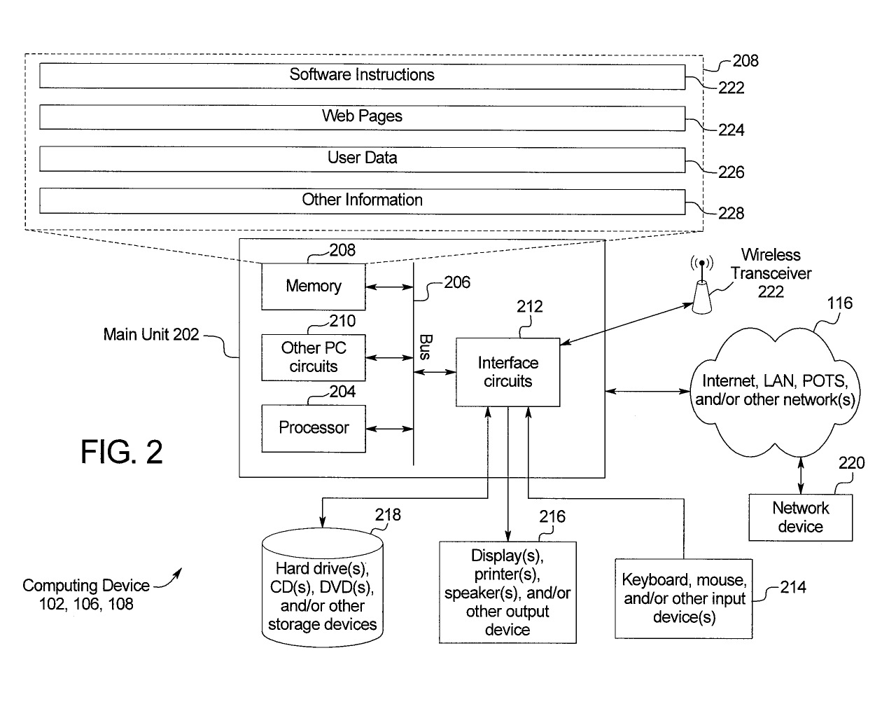

A detailed block diagram of an example computing device 102, 106, 108 is illustrated in FIG. 2. Each computing device 102, 106, 108 may include a server, a personal computer (PC), a personal digital assistant (PDA) and/or any other suitable computing device. Each computing device 102, 106, 108 preferably includes a main unit 202 which preferably includes one or more processors 204 electrically coupled by an address/data bus 206 to one or more memory devices 208, other computer circuitry 210 and one or more interface circuits 212. The processor 204 may be any suitable microprocessor.

The memory 208 preferably includes volatile memory and non-volatile memory. Preferably, the memory 208 and/or another storage device 218 stores software instructions 222 that interact with the other devices in the system 100 as described herein. These software instructions 222 may be executed by the processor 204 in any suitable manner. The memory 208 and/or another storage device 218 may also store one or more data structures, digital data indicative of documents, files, programs, web pages, etc. retrieved from another computing device 102, 106, 108 and/or loaded via an input device 214.

The example memory device 208 stores software instructions 222, web pages 224, user data 226 and other information 228 for use by the system as described in detail below. It will be appreciated that many other data fields and records may be stored in the memory device 208 to facilitate implementation of the methods and apparatus disclosed herein. In addition, it will be appreciated that any type of suitable data structure (e.g., a flat file data structure, a relational database, a tree data structure, etc.) may be used to facilitate implementation of the methods and apparatus disclosed herein.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint and/or a voice recognition system.

One or more displays, printers, speakers and/or other output devices 216 may also be connected to the main unit 202 via the interface circuit 212. The display 216 may be a cathode ray tube (CRT), liquid crystal display (LCD), or any other type of display. The display 216 generates visual displays of data generated during operation of the computing device 102, 106, 108. For example, the display 216 may be used to display web pages received from the application server 106. The visual displays may include prompts for human input, run time statistics, calculated values, data, etc.

One or more storage devices 218 may also be connected to the main unit 202 via the interface circuit 212. For example, a hard drive, CD drive, DVD drive, flash memory drive and/or other storage devices may be connected to the main unit 202. The storage devices 218 may store any type of data used by the computing device 102, 106, 108.

Each computing device 102, 106, 108 may also exchange data with other computing devices 102, 106, 108 and/or other network devices 220 via a connection to the communication channel(s) 116. The communication channel(s) 116 may be any type of network connection, such as an Ethernet connection, WiFi, WiMax, digital subscriber line (DSL), telephone line, coaxial cable, etc. Users 118 of the system 100 may be required to register with the application server 106. In such an instance, each 118 user may choose a user identifier (e.g., e-mail address) and a password which may be required for the activation of services. The user identifier and password may be passed across the communication channel(s) 116 using encryption built into the user's browser, software application, or computing device 102, 106, 108. Alternatively, the user identifier and/or password may be assigned by the application server 106.

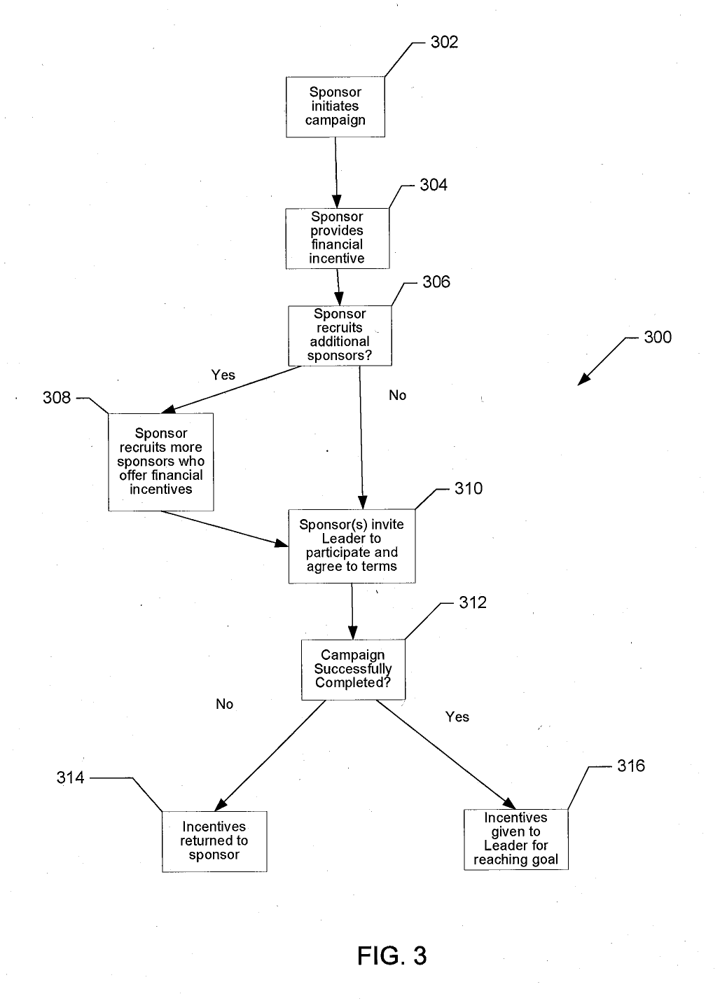

A flowchart of an example process 300 for incenting behavior is presented in FIG. 3. FIG. 3 illustrates an example flow diagram of the general process used by a sponsor to set up and initiate a campaign or rally to provide financial incentives to incite behavior change in another individual, the leader. Preferably, all of the process described herein is at least partially embodied in one or more software programs which are stored in one or more memories and executed by one or more processors. Although these processes are described with reference to the flowcharts, it will be appreciated that many other methods of performing the acts associated with process 300 may be used. For example, the order of many of the steps may be changed and some of the steps described may be optional.

In this example, at step 302, the sponsor initiates a campaign by arriving at a website and choosing a module that can be used to affect behavior change. The sponsor may choose an existing module such as quitting smoking, weight loss, medication compliance, or improving grades, or may design a custom incentive program. At step 304, the sponsor may choose to provide a financial incentive for successful completion of the campaign. Then, the sponsor can invite a leader to participate in the campaign and agree to the terms of the campaign at step 310. In one embodiment, before proceeding to step 310, the sponsor may recruit other sponsors at steps 306 and 308 who can also provide financial incentives for successful completion of the campaign. The terms of the campaign may be based on the module selected by the sponsor. If the leader agrees, the campaign begins. A sponsor may provide incentives after the campaign has begun. In addition, sponsors may provide other non-financial rewards such as clothing, furniture or cookware for reaching a goal. If the leader successfully completes the campaign at step 312, he receives the financial incentives as shown in step 316. If the leader does not successfully complete the campaign, the financial incentives are returned to the sponsors as shown in step 314. In one embodiment, the leader receives financial incentives proportional to the amount of the campaign that has been successfully completed. For example, if the leader completes 75% of the campaign, he may receive 75% of the financial incentives and the remaining 25% is returned to the sponsors. The incentives returned to the sponsors may be allocated to each sponsor according to the amount originally provided by that sponsor.

Each sponsor preferably sets up a sponsor profile. The primary sponsor enters his information such as first name, last name, email address, website, year of birth, zip code, relationship with leader (such as friend, co-worker or relative) and uploads a photo to associate with his profile. Alternatively, the sponsor can also choose to import this information from another program. Next, the sponsor enters the information about the leader, such as first name, last name, email address, year of birth, etc.

The sponsor may also choose a campaign start date and time, a length of campaign and a number of periods in the campaign. The campaign periods may be tied to specific goals reached instead of being based on time. For example, losing 10 pounds brings period 1 to a close, losing the next 20 pounds brings period 2 to a close, etc.

In one embodiment, the sponsors can select from a list of supplied compliance factors, which may vary depending on the module selected by the sponsor. For example, compliance factors for a QuitSmoking module may be: “Write down your reasons for wanting to quit and keep the list with you to read when you need a reminder,” “Update your supporters about your progress once a week,” “Throw away all of your cigarettes, lighters and ashtrays,” “Purchase replacements to put in your mouth instead of cigarettes, such as peppermints, carrot sticks, toothpicks, or cinnamon sticks,” “Join a smoking cessation group and attend it weekly,” or “Upload a picture showing a nicotine patch on your arm.” An example compliance factor for a WeightLoss module may require the leader to upload a picture or video of himself stepping on a scale. An example compliance factor for an ImproveGrades module may require the leader to upload completed homework assignments or show screenshots of the homework being done. In one embodiment, a sponsor can add custom compliance factors.

In one embodiment, checking whether compliance factors have been met may require mechanical or chemical tests. These mechanical and chemical tests could be provided by outside laboratories or service providers, or may require specialized tools to validate compliance with the compliance factors. Example tests and tools may include a cotine test to check for nicotine abstinence, a weight scale digitally linked to the Internet to monitor weight loss, or pedometers to measure workouts. Other ways to monitor compliance may include information uploaded by a third party such as a verified weight loss program, smoking cessation program, school administrators, doctors, etc. The primary sponsor may then determine whether a compliance factor is negotiable with other potential sponsors or the leader.

Next, the sponsor may choose a completion time frame for each compliance factor, such as, the compliance factor must be completed prior to a campaign end date, or must be updated each day, week or month, or each day by 7 pm, etc.

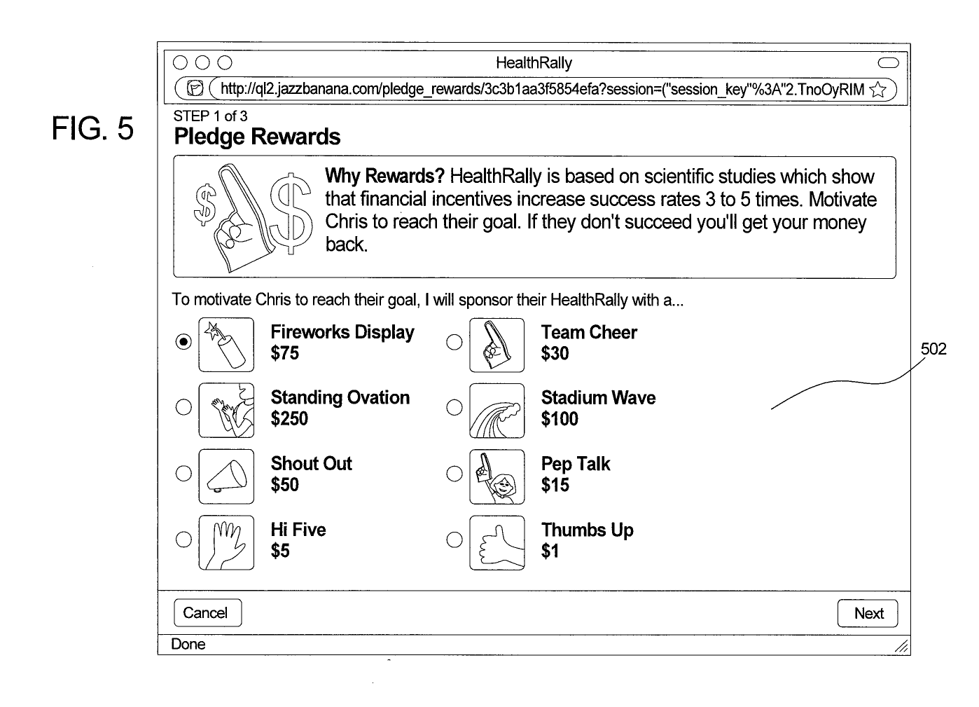

The sponsor may then select a total sponsorship amount he wants to provide as a financial incentive from a suggested list. FIG. 5 is an example screen illustrating different rewards that a sponsor can select. The sponsor can choose one of many different rewards 502. In one embodiment, the sponsor may be able to choose non-financial rewards, such as Making a Gift Basket, or Help out With Chores.

Alternatively, the sponsor may type in his own amount or other motivational reward. The system may then calculate an amount per period by dividing the total amount by the number of periods or by using algorithms that distribute rewards differentially across periods. Or, a sponsor may provide a smaller reward in earlier periods and larger rewards in later periods, encouraging the leader to continue with the campaign to earn greater rewards. For example, a sponsor may pledge $90 for a three-month campaign with three periods. In such an example, the amount per period would be $30. Or the sponsor may choose to spread the reward across the periods such as $15 for the first period, $30 for the second period and $45 for the third period, or in any number of ways as appropriate. The reward amount per unit of time, for example, per minute or per hour, could also be automatically calculated and presented to the sponsor. The sponsor may then read and sign a social contract consistent with the selected terms. The social contract summarizes the terms of the campaign, such as the compliance factors and financial incentives offered. In one embodiment, the leader agrees to the social contract by clicking a “Start My Campaign” button.

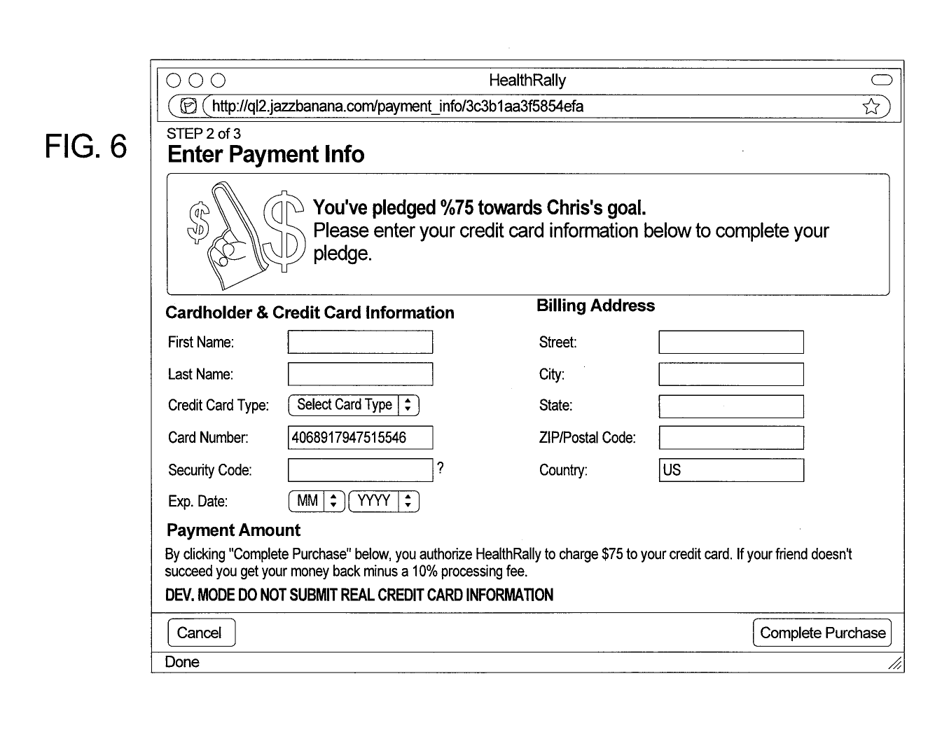

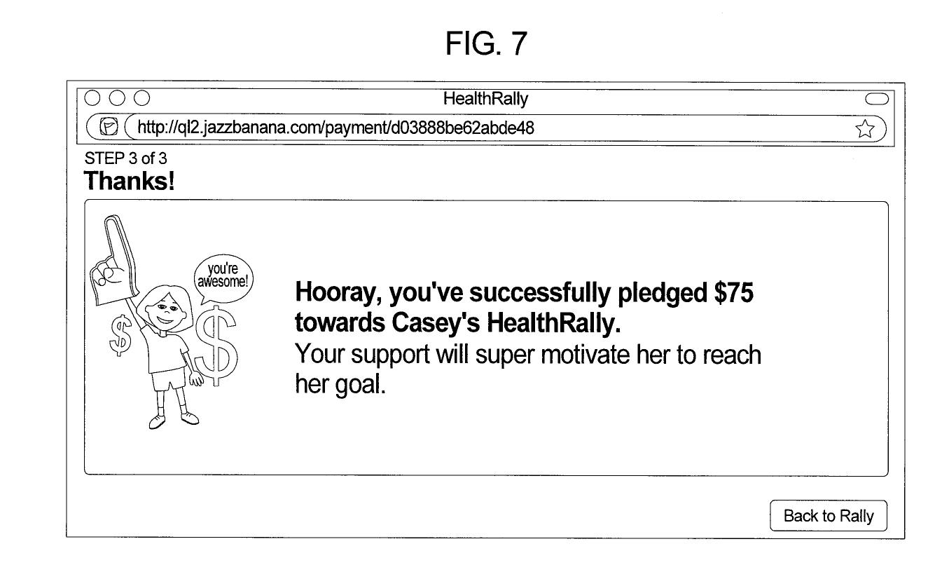

The sponsor is asked to add to his payment information such as credit card number or other payment information. FIG. 6 is an example screen illustrating a payment screen. In the example screen in FIG. 7, the sponsor completes pledging $75.

A primary sponsor may also recruit additional sponsors. Each additional sponsor enters his information such as name, email address, etc. The primary sponsor may also indicate whether or not these additional sponsors are permitted to invite more sponsors, and whether those invited sponsors can invite more sponsors, etc. In this way, the primary sponsor can influence the size of the social network of supporters.

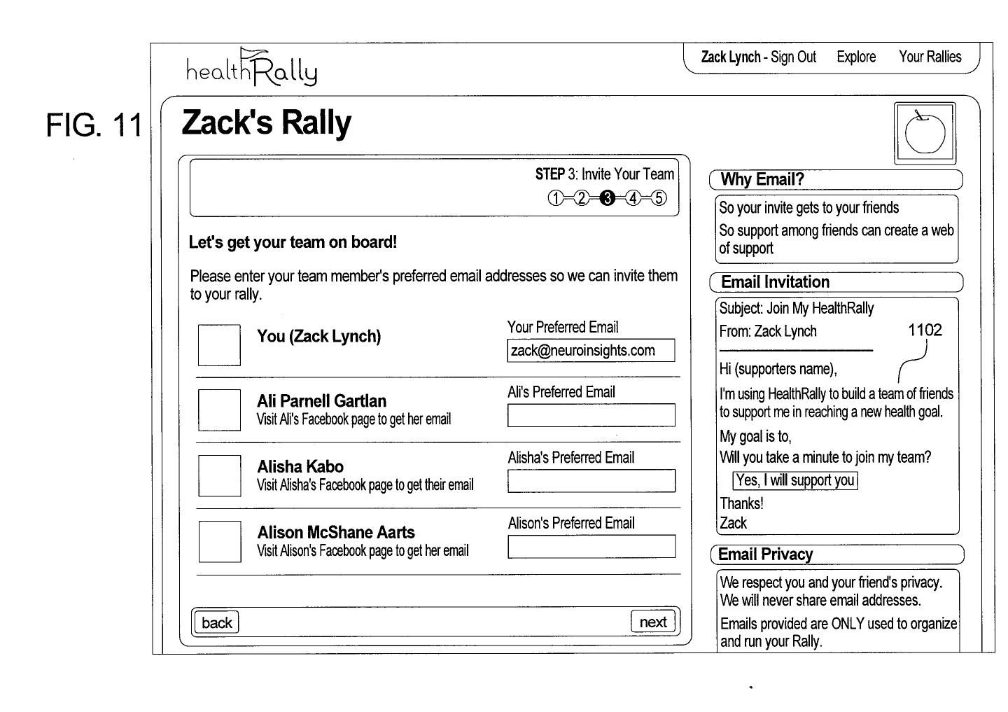

Preferably, a primary sponsor is then shown an automated message that is based on the module chosen, as illustrated by item 1102 in FIG. 11. The primary sponsor can send that message to each potential sponsor, or modify that message before sending it to each potential sponsor. In one embodiment, the sponsor may remain anonymous to the leader.

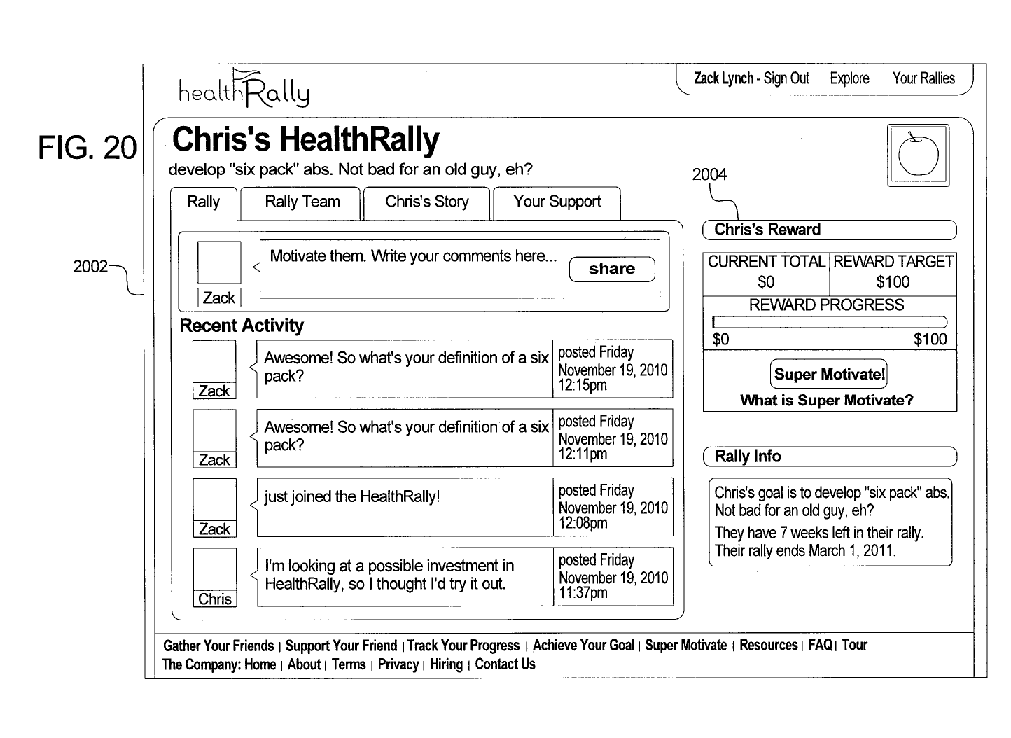

Each potential sponsor may then choose to join the campaign, not join the campaign or ignore the invitation. An interested potential sponsor may click a button to join the campaign and is preferably hyperlinked to a webpage, such as the example screen in FIG. 20.

The new sponsor checks, and changes if necessary, his contact information such as name, email, etc., which is already populated based on the unique email sent to them and their email response to the invitation. Each sponsor may upload a photo or video and has the ability to be anonymous or create a screen name alias. Each new potential sponsor may choose from a list how much he wants to sponsor, or each sponsor may type in his own amount as shown in FIGS. 5-7. This pledge amount is used to update the amount towards total sponsorship.

Each new potential sponsor may read over the compliance factors chosen by the primary sponsor and accept those compliance factors. Each new potential sponsor may also choose to sign up for the campaign and read the social contract. The new sponsor's information such as name, alias and amount of sponsorship may then be populated into a table that lists all of the sponsors for a campaign. If enabled by the primary sponsor, the new sponsor may also invite other potential sponsors.

If the primary sponsor enabled any compliance factors to be negotiable, then each new potential sponsor may choose to suggest changes to the compliance factors. Suggesting changes to the compliance factors preferably sends the potential new sponsor to a compliance negotiation page.

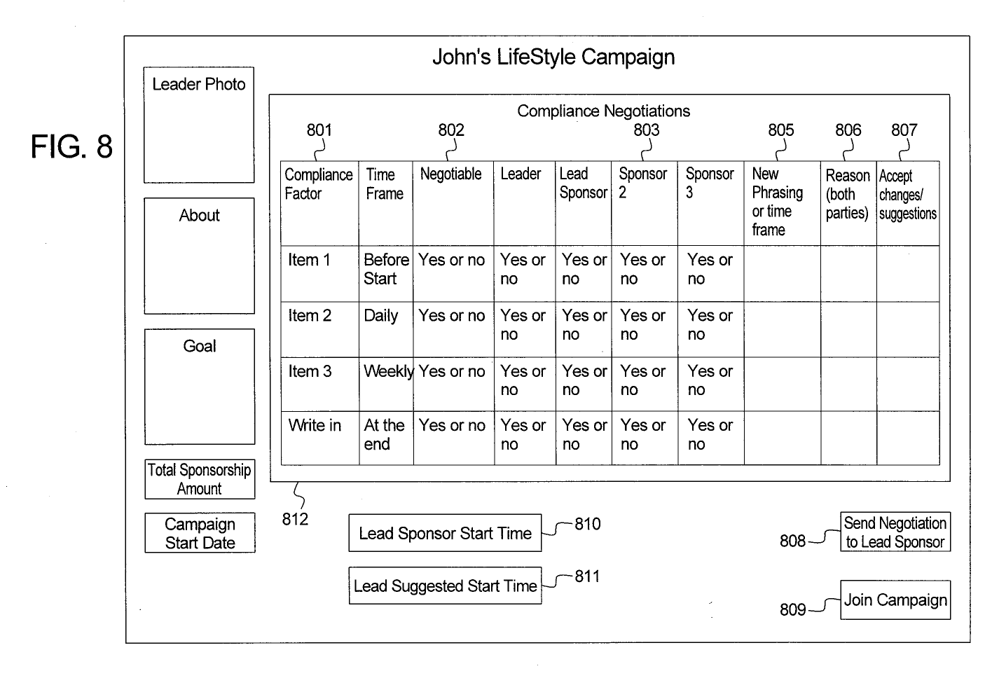

FIG. 8 shows an example compliance and time frame negotiation table where the potential new sponsor can indicate that he would like to change a specific or multiple compliance items such as the time at which a compliance item must be proven. For example, a potential new sponsor may be able to require that photos of homework are provided daily, or that a leader prove that he went to a meeting, or that the leader update his progress by a particular time each night, etc. The potential new sponsor may suggest a new time frame or new wording of the compliance factor, or that items be deleted, etc., as shown in item 805. The potential new sponsor may also add his own compliance factor item, such as, for example, uploading of a picture daily, taking a picture of completed homework, taking a video of a scale, writing short status updates each day, joining a self-help group, etc., as shown in item 812. The potential new sponsor may also provide his reasoning for the suggested changes and/or additions to each compliance item, as shown in item 806. Once there is a difference registered in sponsor column 803 that differs from the primary sponsor's input for that compliance factor, the row is preferably highlighted to reflect a need for negotiation. At the end of any changes, the potential new sponsor may send an updated list of compliance factors with differences to the primary sponsor by pressing button 808.

The primary sponsor then receives a message and clicks a link to go to a compliance negotiation page and accepts or rejects the changes, as shown in item 807. A message is then sent to the new potential sponsor with a link to the results on the compliance negotiation page. The new potential sponsor is asked to join the campaign with the resulting compliance factors by pressing button 809.

If enabled by the primary sponsor, a new sponsor can invite other new sponsors. To do so, the sponsor enters the names and information for the other new sponsors. For example, the sponsor may do this by uploading such information from an address book or other social software applications. A message may then be sent to the primary sponsor that a new sponsor signed up and that new sponsor is inviting more potential sponsors. This process may continue until such a time that the primary sponsor wants to start the campaign by inviting the leader.

The primary sponsor may then send the leader a welcome email message, which may be automatically generated for the primary sponsor by the system. The primary sponsor preferably reviews the email and clicks a button to modify the email or sends the email in its original form.

The leader then receives the welcome message, which preferably includes names of the sponsors and an amount of total sponsorship. Sponsors can also choose to pledge sponsorship incentives during the campaign. The leader may then click a link to read more about the campaign.

The leader may also review a personal campaign page prior to starting the campaign to add or change personal information. Preferably, the leader reviews and agrees to compliance factors, initial pledge amount, time frame, start time and date. In addition, the leader preferably reads and accepts the social contract. At this time the leader can now post to a status update board. A message is then sent to the primary sponsor that the leader has accepted the campaign. Preferably, all sponsors are then sent an email message notifying them that the leader has accepted the terms and conditions and has given them a hyperlink to add to their payment information such as credit card number or other payment information. On the campaign start date, the credit cards are preferably charged for the first period amount or for all periods. In one embodiment, payments will be charged throughout the campaign as milestones are reached and rewards are paid out to the leader at a variety of times based on the compliance factors. These financial incentives are preferably held in the system in any of a variety of ways, such as, for example, a bank account. In one embodiment, a leader may declare success and sponsors may or may not choose to provide financial incentives. For example, a sponsor may not believe that the leader has not smoked a cigarette in the past 6 months.

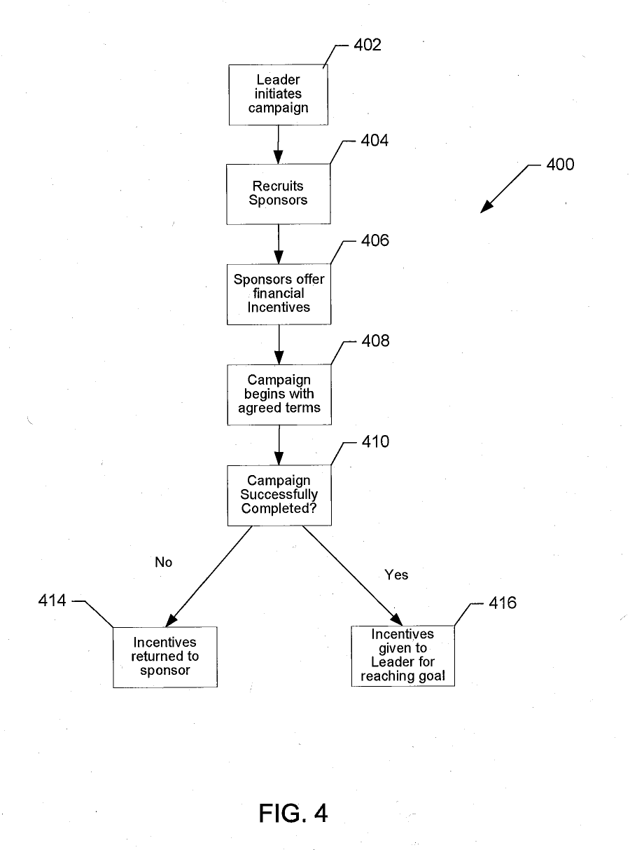

In one embodiment, a leader may begin a campaign to incent a behavioral change in himself. A flowchart of an example process 400 for incenting behavior is presented in FIG. 4. Preferably, all of the process described herein is at least partially embodied in one or more software programs which are stored in one or more memories and executed by one or more processors. Although these processes are described with reference to the flowcharts, it will be appreciated that many other methods of performing the acts associated with process 400 may be used. For example, the order of many of the steps may be changed and some of the steps described may be optional.

At step 402, a leader initiates a campaign. The leader may choose an existing module such as quitting smoking, weight loss, medication compliance, improving grades, or may design a custom program incentive program. At step 404, the leader recruits a sponsor or multiple sponsors to support his campaign. If the sponsors agree to the terms of the campaign, the sponsors may provide financial incentives to complete the campaign at step 406. In one embodiment, the leader may ask for certain financial incentives in step 402 before recruiting the sponsors. In one embodiment, the leader may begin a campaign without any financial incentives pledged. Sponsors may then pledge incentives after the campaign has begun. The campaign begins at step 408. If the leader successfully completes the campaign at step 410, he receives the financial incentives as shown in step 416. If the leader does not successfully complete the campaign, the financial incentives are returned to the sponsors as shown in step 414. In one embodiment, the leader receives financial incentives proportional to the campaign that has been successfully completed. For example, if the leader completes 75% of the campaign, he may receive 75% of the financial incentives and the remaining 25% is returned to the sponsors. The incentives returned to the sponsors may be allocated to each sponsor according to the amount originally provided by that sponsor. In one embodiment, even if the leader does not complete the campaign, a sponsor may elect to provide all of the pledged rewards to the leader.

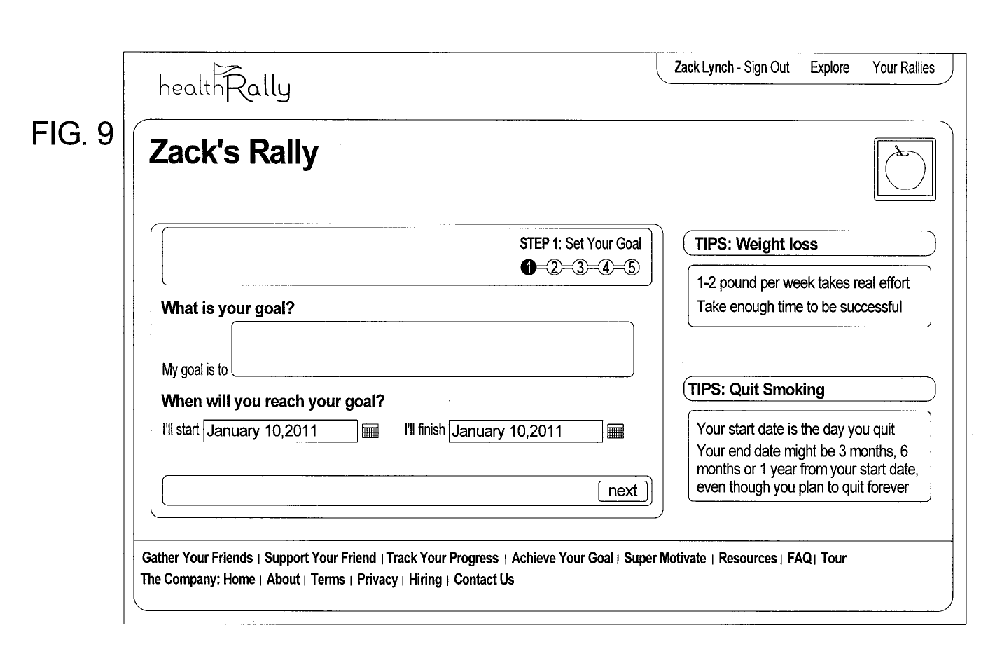

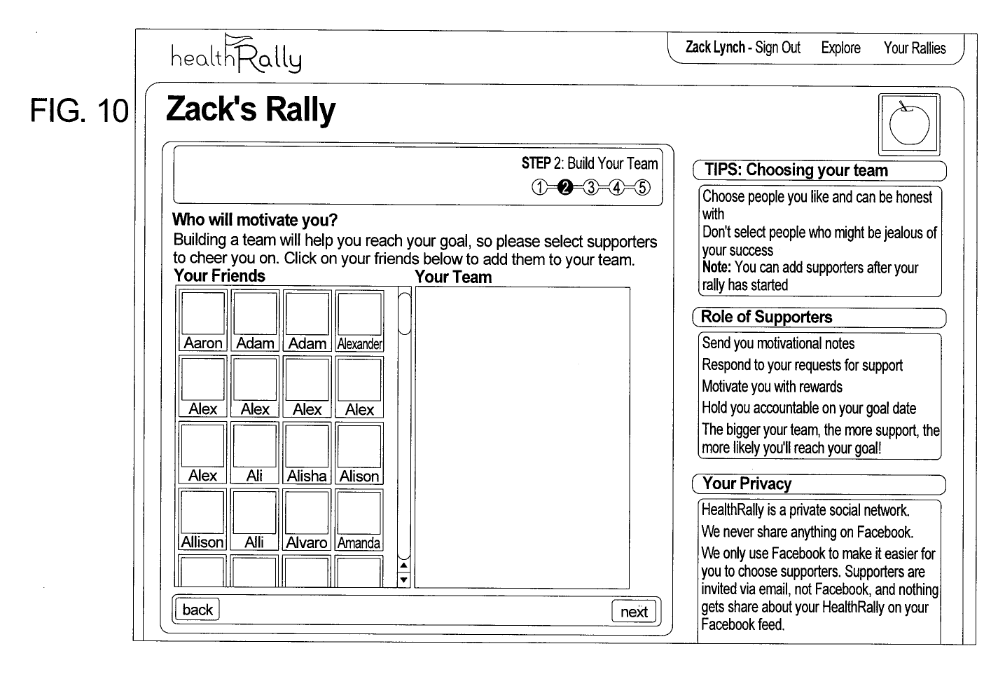

To initiate the campaign, the leader sets up a leader profile and enters information such as name, email and date of birth, and uploads photos of himself. This information can also be imported from other information systems. The leader then enters his goal with start and end dates and number of campaign periods. An example goal definition screen is illustrated in FIG. 9. The leader then selects and enters the information about his potential sponsors. FIG. 10 illustrates an example screen presented to a leader for selecting supporters. All of the selected supporters are then displayed to the leader, as shown in FIG. 11.

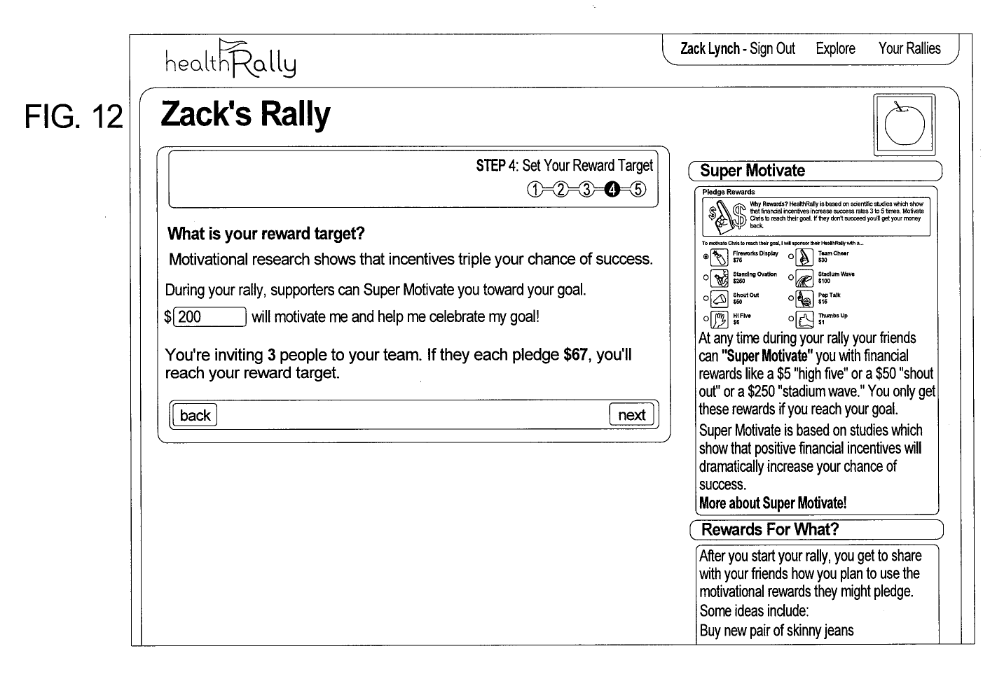

The leader then determines a target reward amount and the system calculates the amount per potential supporter that would be required to reach the target reward amount. FIG. 12 illustrates an example rewards target screen.

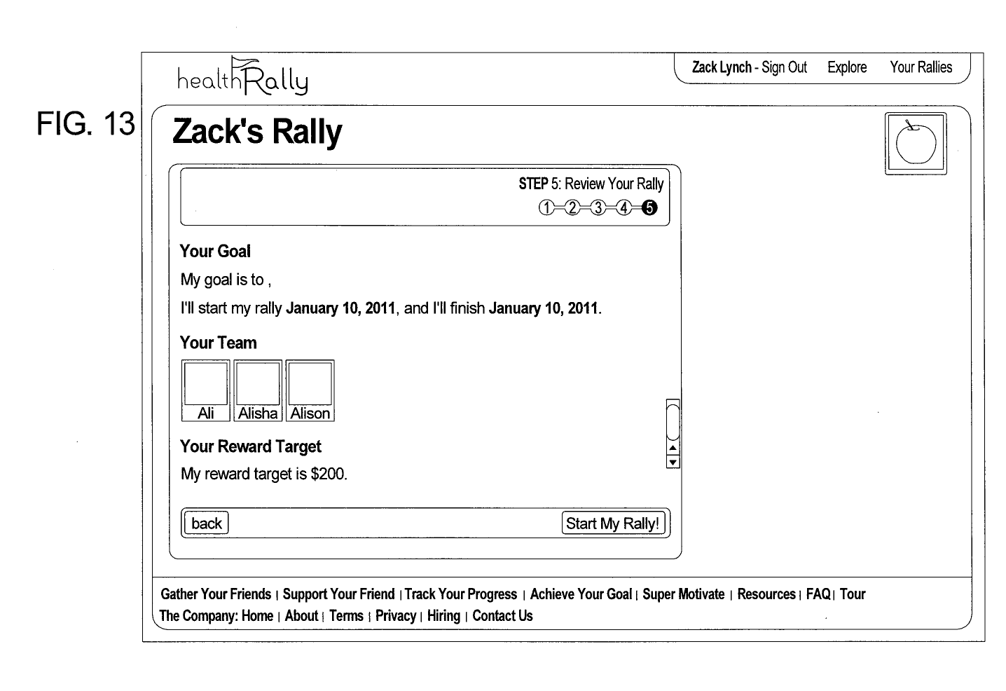

The system preferably calculates an amount per period, an amount per minute, etc. for the target reward amount. The leader may then enter one or more compliance factors, select if compliance factors are negotiable and then read and agree to a social contract. In one embodiment, the leader may not enter any compliance factors, and only enter a goal that is to be achieved. The system displays a campaign summary screen to the leader. FIG. 13 illustrates an example campaign summary screen.

The leader may or may not choose to enter information about a potential primary sponsor and the system shows the leader an “Invite Primary Sponsor” email. The leader may then review and send the email. Each potential primary sponsor receives the email and may accept the offer to join the campaign. If a potential primary sponsor is not interested, then process continues until at least one potential primary sponsor accepts the offer. The leader may also choose not to have a primary sponsor at which time the leader has the capabilities of the primary sponsor, and all potential sponsors are simultaneously invited to the campaign. Preferably, the leader then returns to the website and enters information for additional potential sponsors, such as name, email, and phone number, or this information may be uploaded from spreadsheets, databases, or other email programs. The leader then chooses how many layers of the social network can invite potential sponsors. In one embodiment, only the first group of potential sponsors can invite other potential sponsors. In one embodiment, potential sponsors of potential sponsors can invite other potential sponsors. In this way, the leader can influence the size of the social network of supporters.

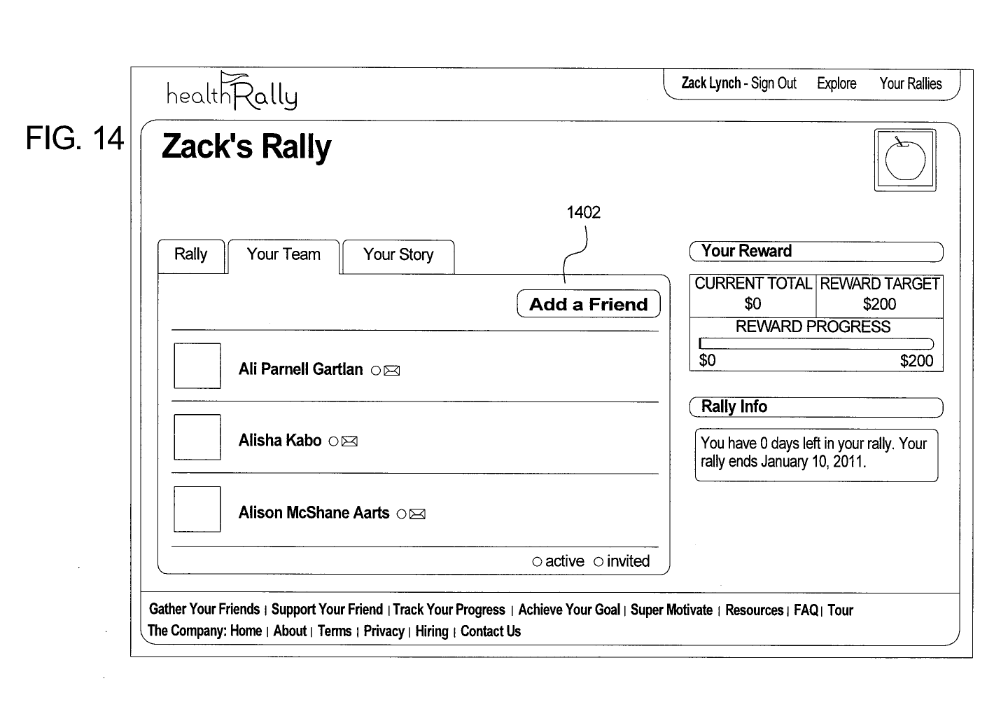

The leader may be able to review all of his supporters. FIG. 14 illustrates an example screen where a leader can review all of his supporters. The leader can recruit additional sponsors at any time by pressing button 1402. The leader then sees an “Invite Sponsor” email to potential sponsors, which may be modified by the leader or sent to the potential sponsors in its original form. Alternatively, the system automatically generates and sends an email to potential sponsors. Potential sponsors then preferably click a “Join Campaign” or “Join Rally” button to indicate their interest in sponsorship. Potential sponsors may then go to a personalized campaign page for recruiting additional sponsors. Preferably, new sponsors are asked to enter or change their personal information, review compliance factors, negotiate compliance factors, negotiate start time, enter pledge amount, read the social contract, etc. Preferably, each sponsor's name and photo are now used in the status update and appear as supporters of the campaign. Sponsors may invite others to join the campaign if allowed by the leader. The process of inviting potential sponsors continues until the leader decides to start the campaign or the campaign start time and date are reached. Additional sponsors can be added to the campaign after it has begun by using the “Add a Friend” feature, button 1402, in FIG. 14.

In one embodiment, a campaign involves multiple leaders. Each leader competes against the other leaders to complete the campaign. For example, five friends may wish to quit smoking within one year. The five friends may establish a campaign and recruit sponsors to support them. Alternatively, a sponsor or sponsors may launch a campaign for the five friends to quit smoking within one year. The financial incentives for completing the campaign may be $10,000. Each friend, or leader, tries to quit smoking within one year. At the end of the campaign, only the leaders that successfully quit smoking receive any financial incentives. If no one is successful, the $10,000 is returned to the sponsors proportional to the amount originally pledged by each sponsor. If only one leader is successful, he receives the entire $10,000. If two leaders are successful, the two leaders each receive $5,000. If all five leaders are successful, each leader receives $2,000.

In one embodiment, each leader must successfully complete the campaign for any leader to receive any portion of the financial incentive. This embodiment encourages each leader to incentivize every other leader to complete the campaign.

At the start of the campaign, sponsors are charged for the first campaign period or all periods using each sponsor's selected payment method. The charged amount is held by the system in any of a variety of methods, such as in a bank account, and the campaign continues until the campaign is successfully completed, or the campaign is unsuccessful and the contract is broken. In one embodiment, sponsors may pledge additional monetary incentives or motivating gifts during the campaign. Any additional money pledged is held in the same manner as the initial money pledged.

Once the campaign begins, the leader and sponsors can update the website and communicate with each other about the campaign and about compliance factors. The sponsors and the leaders may communicate about progress towards the compliance factors via these updates that are displayable to everyone participating in the campaign. During this time, the percent progress towards goal chart, the amount earned during a period and the amount earned to date is preferably updated and displayed to the leaders and sponsors. At the end of the first successful period where the leader has met their interim goal, the leader may declare success. Thus, the leader can let his supporters know that he has successfully completed a portion of the campaign. This may provide additional peer motivation which helps sustain the campaign and helps the leader complete the entire campaign.

Supporters may be notified and ask to validate that the leader has achieved a goal—either for a portion of the campaign, or the entire campaign. If, through the process of validation, the sponsors in whole or in part agree that the leader has reached a goal then the leader may elect to receive a sponsorship award for achieving that goal. This money can come in the form of a check sent to the leader, it can be transferred to a bank account or the leader can receive a certificate that can be redeemed at specified service providers within a network of preferred providers, such as weight loss centers, gyms, computer service centers, online gaming networks, etc.

For example, a leader may successfully complete the first period and declare success. A message is then sent to the primary sponsor and to other sponsors who have opted in for updates that the first period was successful and that second period has begun. If sponsors have not already been charged, they are now charged for a second period using each sponsor's selected payment method. Preferably, when the second period begins, the award for the first period is provided to the leader, the amount earned to date is updated and the amount earned during the current period is reset to zero.

As the campaign continues, the leader and sponsors may continue to communicate with each other about the campaign and about compliance factors. When the goal for the second period is reached, the leader preferably chooses a method to receive the award for the second period. Each sponsor then receives an email update that period 2 was successful and that period 3 has begun. If sponsors have not already been charged, each sponsor is charged for the period using the payment method selected by the sponsor. This process continues until the goal is reached for the final period, so that at the end of the time frame all of the compliance factors have been met. The leader then chooses a method to receive awards for the last period. Fees are accessed for use of the service if they have not been previously collected and the leader receives the final award. On completion of the process, the leaders and sponsors preferably receive a congratulatory message. The leaders and the sponsors may then receive a “Help someone else” message suggesting they start a new campaign for another person.

In one embodiment, a campaign can be stopped if the social contract is broken because the leader did not meet one or more of the compliance factors. For example, the leader or leaders may fail to provide timely updates, refrain from smoking cigarettes, lose a specified amount of weight, take their medication on time, or receive higher grades as required by the social contract. Failure to meet compliance factors and break the social contract may be reported by sponsors to the primary sponsor, by the leader, or by a trusted third party diagnostic provider. Once a contract has been broken and the primary sponsor agrees that the terms have been violated, then the campaign is suspended for a period of time. For example, the campaign may be suspended for one hour, 24 hours, or one week. Once the campaign is suspended, the leader preferably receives an email that the campaign has been suspended. The primary sponsor and leader may then negotiate to cancel the campaign, begin a new campaign or resume the current campaign in whole or in part with or without all of the sponsors. In one embodiment, leaders or other sponsors can also determine that the contract has been broken and the campaign must be suspended.

In some instances, the primary sponsor may decide to resume a suspended campaign, or other sponsors other than the primary sponsor will continue to support the suspended campaign. For example, the primary sponsor may decide to resume a suspended campaign if the breach was minor or the suspension was a mistake. In such an instance, a status update is preferably placed on the status board about the decision and an email or status update is sent to other sponsors about suspending or reinstating the campaign. At the end of the period, sponsors are allowed to leave the campaign if they do not agree with the primary sponsor's decision to reinstate the campaign.

If a campaign is cancelled, the sponsors and/or leader are charged fees. For example, 10% of the pledged amount may be charged. Sponsors are then returned the remaining money for that period or the remaining periods using the payment method they used to sponsor the campaign, or a different method elected by the sponsor. For example, the money may be returned to the sponsor by crediting a credit card or mailing a check. The leader then receives the reward earned up to the point of contract cancellation and the leader and sponsors preferably receive a message that the campaign has ended.

In one embodiment, the leader may not agree to the terms as presented. For example, the leader may think it would be just too difficult to lose ten pounds in three months, but believes he can do so in six months. The leader may want the opportunity to earn the reward by losing ten pounds in six months. In that case, the leader may negotiate with the sponsors to modify the compliance factors. In one embodiment, the leader can email the sponsors his proposed changes to the compliance factors.

For example, the leader may be able to negotiate compliance factors and/or start date with the primary sponsor. Once the leader is invited by one or more sponsors, the leader preferably receives a welcome email, clicks a button to learn more about the campaign, reviews the information presented and makes any changes necessary to his personal information. Then, the leader may be able to negotiate compliance factors and/or start time or date of the campaign. The leader may then make suggested changes to compliance factors and/or the start time and send proposed changes to the primary sponsor who may then accept or reject proposed changes. The leader and sponsor can negotiate over compliance factors until they agree, and then the leader is given an opportunity to accept the modified campaign. If the modified campaign is accepted, the campaign begins. If agreement cannot be reached, the campaign never begins.

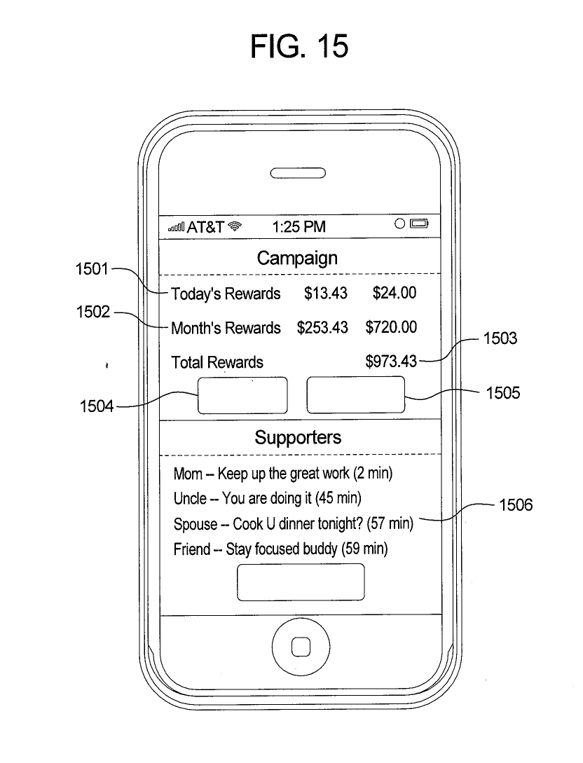

In one embodiment, the system may be accessible to sponsors and leaders from a mobile device. FIG. 15 is a graphical representation of the information that may appear on a mobile device. The mobile application may report the actual rewards earned and the potential rewards that could be earned during a specific period of time, as shown in items 1501 and 1502. The device may display how much a person could potentially make with the whole campaign, as shown by item 1503. The display also includes the user's total rewards earned to date. The display may also include buttons 1504 and 1505 that allow the participants to go shopping in the preferred business provider marketplace and cash in their rewards. The display may also include a way for supporters and the leader to see a live feed of updates 1506 and a way for all parties to update and communicate with each other. Preferably, the mobile application interfaces in a two-way manner with the web application described above.

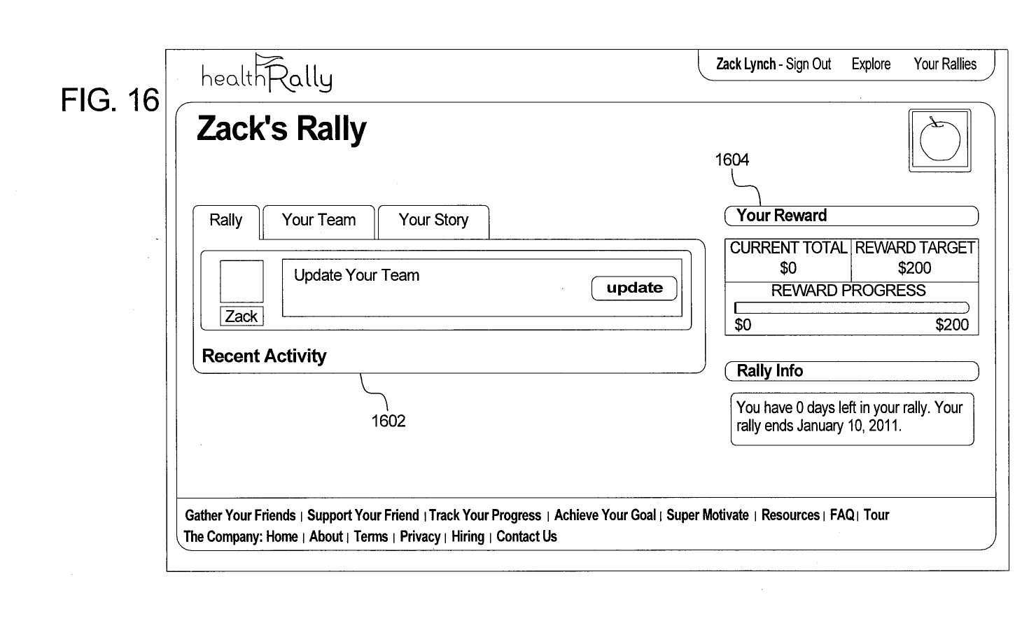

FIGS. 16-29 illustrate additional examples of user interfaces that may be displayed to sponsors and/or leaders.

FIG. 16 illustrates an example screen shot of a campaign page that allows a user to view recent activity 1602 in his campaign and a reward progress bar 1604.

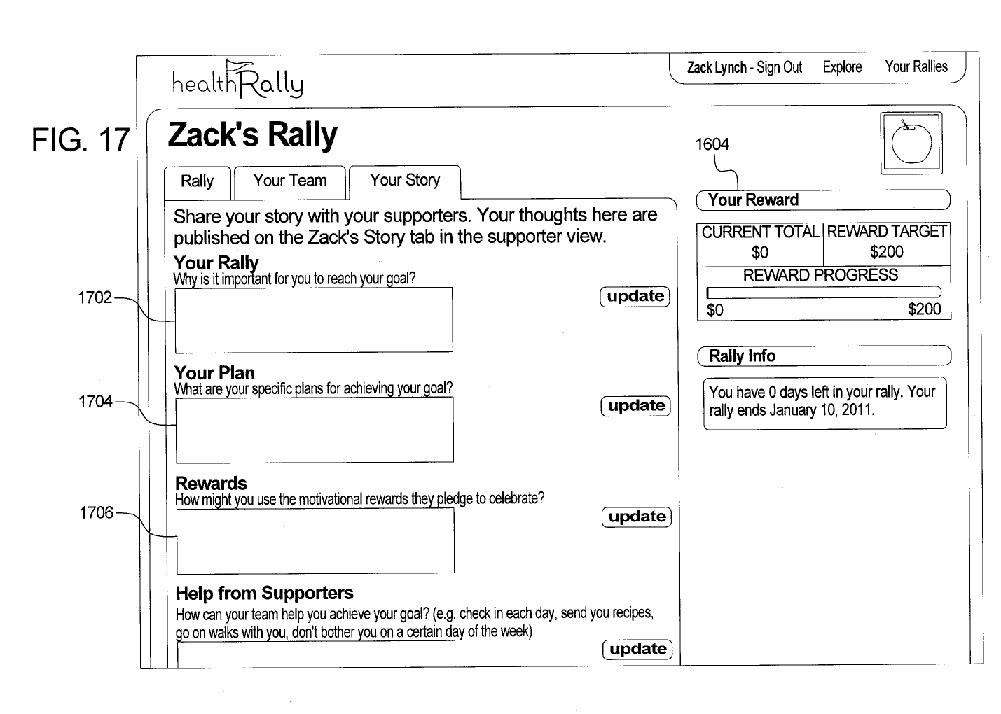

FIG. 17 illustrates an example screen shot of a campaign page displaying a reward progress bar 1604 and the leader's story 1702 for desiring behavior change, plans 1704 to reach the goal, and how he may use earned rewards 1706.

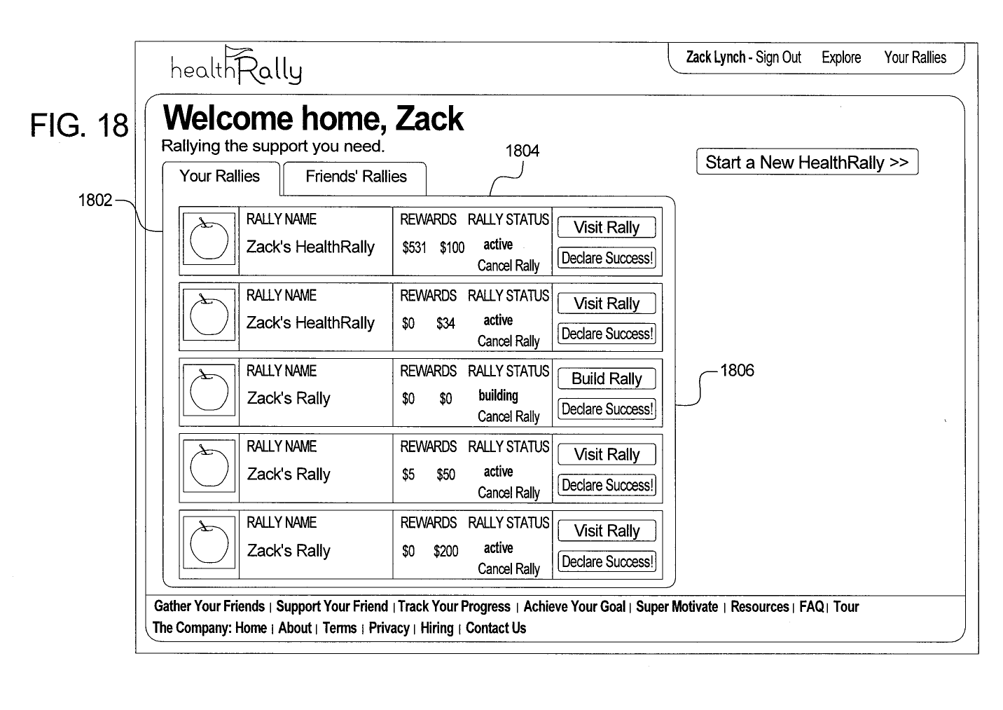

FIG. 18 illustrates an example screen shot of an overview of multiple campaigns 1802 in which the leader is participating. The example page provides an overview of progressions in different campaigns 1804 and allows the leader to declare success, visit campaigns and build campaigns 1806. Thus, the leader can simultaneously view the state of various campaigns.

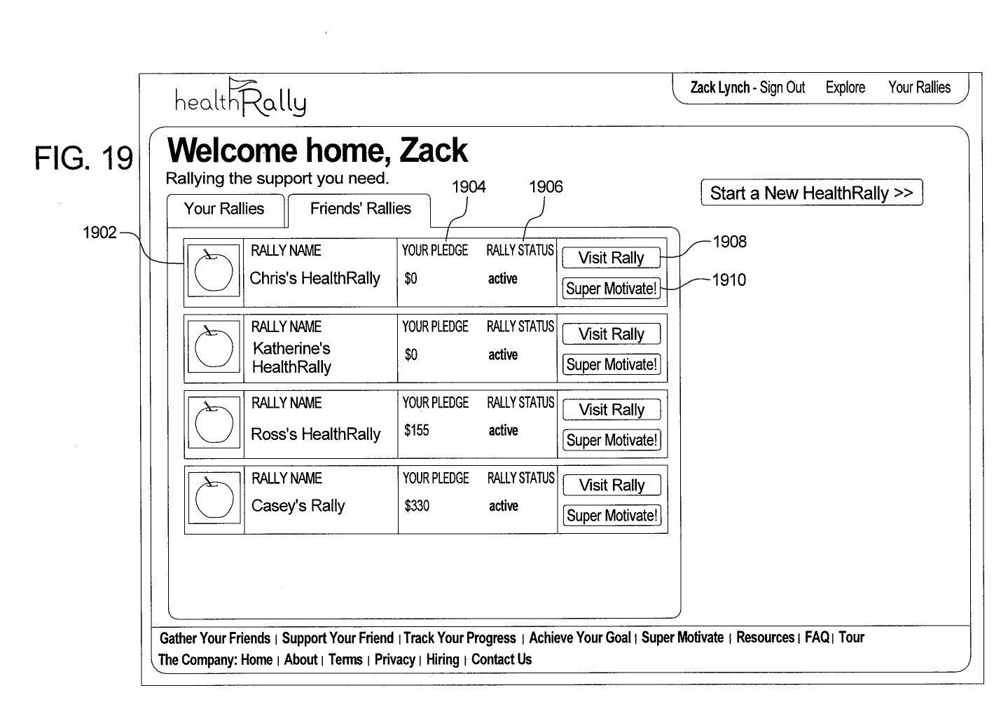

FIG. 19 illustrates an example screen shot of a page that displays multiple campaigns 1902 being sponsored by a sponsor. The sponsor can track the sponsor's pledges for each campaign 1904, view campaign status 1906, and visit campaigns 1908. The sponsor can also pledge rewards as the campaign is progressing 1910.

FIG. 20 illustrates an example screen shot of a campaign page illustrating a leader receiving feedback 2002 from sponsors. Sponsors can offer rewards, or “super motivate” a leader 2004, from that same page.

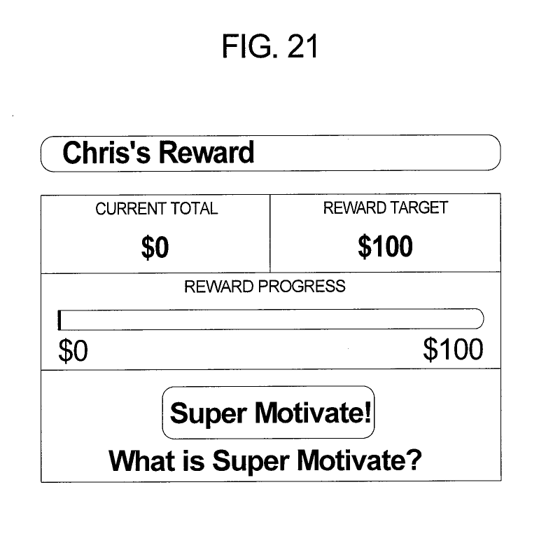

FIG. 21 illustrates an example screen shot of a close-up of a rewards progress bar.

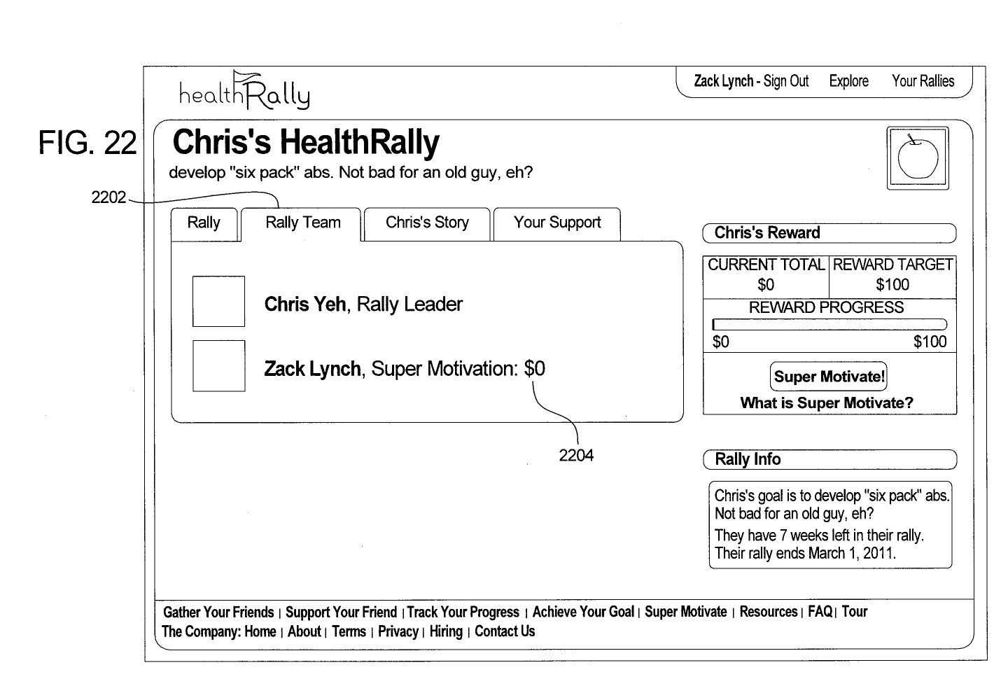

FIG. 22 illustrates an example screen shot of a campaign page showing a team of sponsors 2202 and the amount pledged by each sponsor 2204.

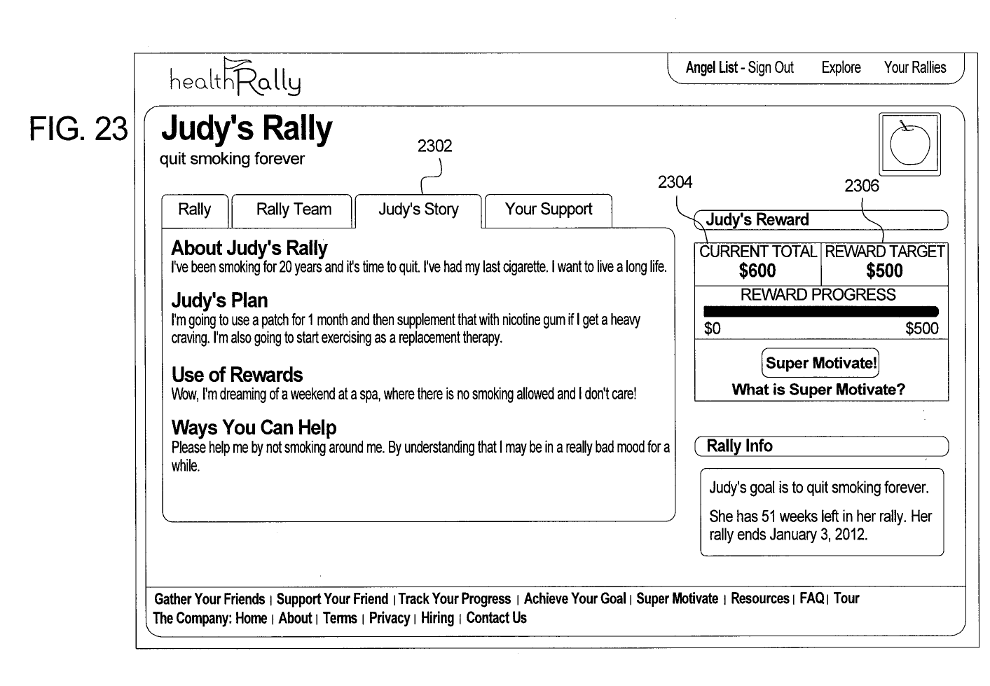

FIG. 23 illustrates an example screen shot of a sponsor page illustrating a leader's story 2302 for desiring behavior change as it appears to sponsors. In one embodiment, depending on what the sponsors pledge, the reward amount 2304 may exceed the reward target 2306.

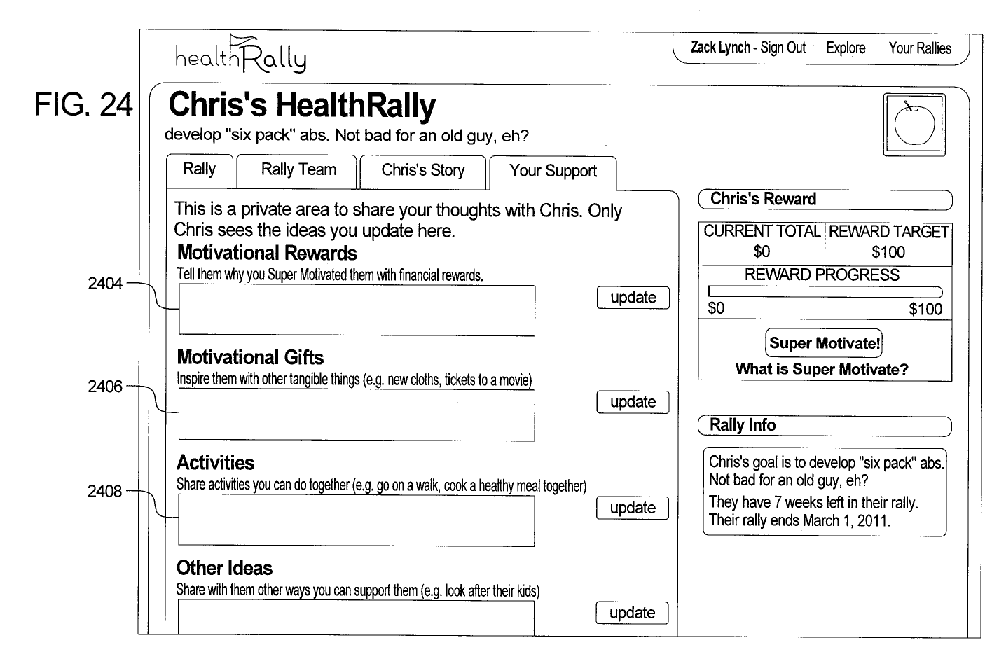

FIG. 24 illustrates an example screen shot of various rewards sponsors may pledge. Sponsors may pledge motivational rewards 2404 other than money, such as gift certificates, value cards, etc. Sponsors may pledge motivational gifts 2406, such as new clothes or movie tickets, or activities 2408 that the sponsor promise to perform with the leader such as cooking a healthy meal together. Thus, sponsors can offer different rewards to the leader to incentivize behavior change.

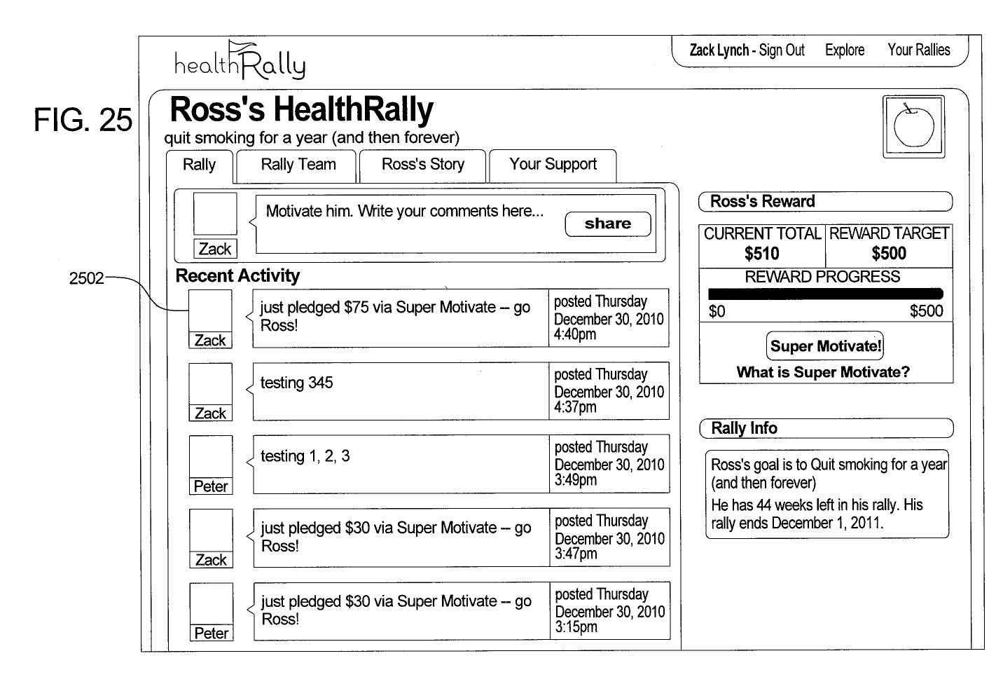

FIG. 25 illustrates an example screen shot of a sponsor's pledge 2502 appearing in real-time in a leader's activity feed.

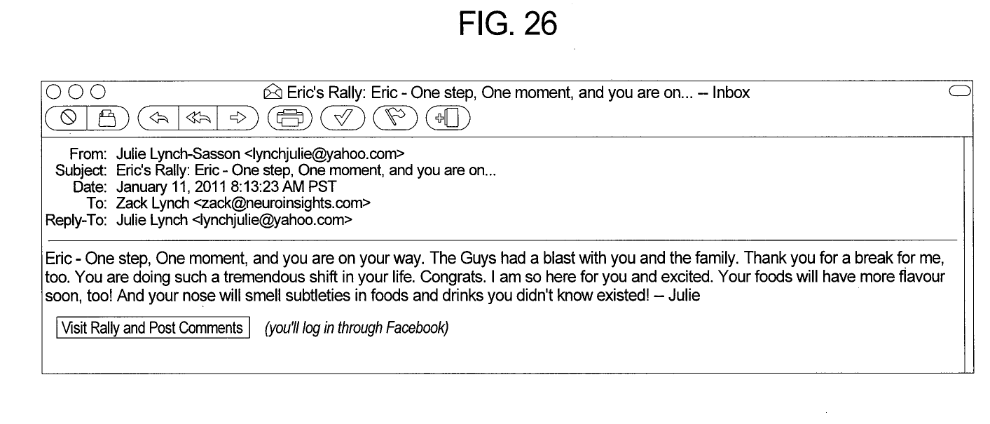

FIG. 26 illustrates an example screen shot of communications from a sponsor to a leader. The system allows participants to communicate in real-time about the campaign.

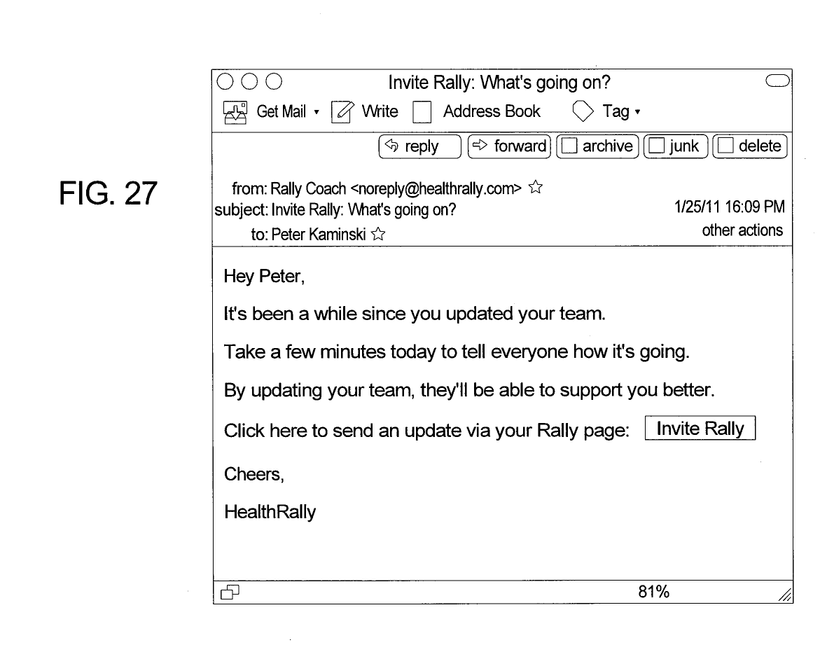

FIG. 27 illustrates an example screen shot of automated reminder technology helping incite behavior change. These are generated by the system throughout the campaign to help leaders reach interim compliance factors (such as update their sponsors once a week) or to help sponsors support the leader more effectively.

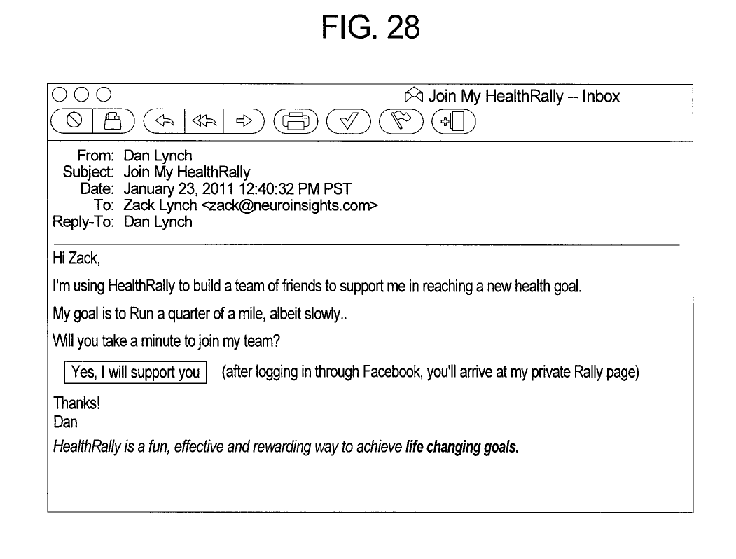

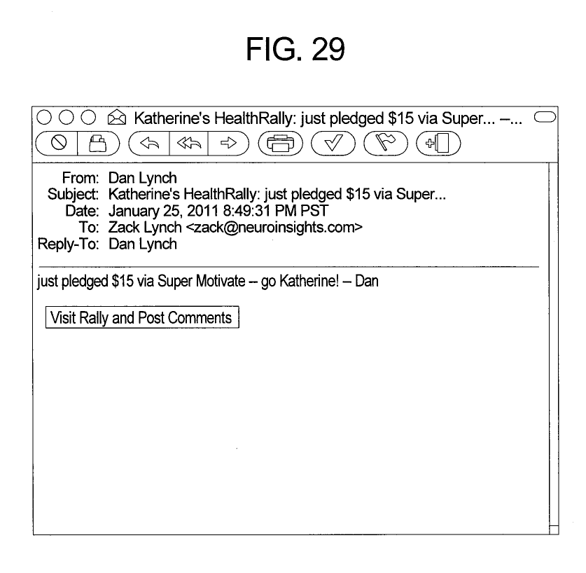

FIG. 28 illustrates an example screen shot of an invitation to join a campaign. FIG. 29 illustrates an example screen shot of an automated message informing a leader that a sponsor has pledged money to help incite behavior change.

In summary, persons of ordinary skill in the art will readily appreciate that methods and apparatus for incenting behavior have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

The invention is claimed as follows:

1. A method of incenting behavior through a campaign, the method comprising:
enabling a user to create a goal;
enabling a first sponsor to offer a financial incentive to a leader in exchange for meeting, at least in part, the goal; and
providing at least part of the financial incentive to the leader for meeting, at least in part, the goal.

2. The method of claim 1, wherein the campaign is initiated by the sponsor and wherein the user that creates the goal is the sponsor.

3. The method of claim 2, further including enabling the first sponsor to recruit a second sponsor to offer the financial incentive to the leader.

4. The method of claim 1, wherein the campaign is initiated by the leader and wherein the user that creates the goal is the leader.

5. The method of claim 4, wherein multiple leaders are offered the financial incentive in exchange for meeting, at least in part, the goal.

6. The method of claim 5, wherein each leader must successfully complete the campaign for any leader to receive any portion of the financial incentive.

7. A computer readable medium storing instructions for incenting behavior through a campaign, the instructions to cause a computing device to:
enable a user to create a goal;
enable a first sponsor to offer a financial incentive to a leader in exchange for meeting, at least in part, the goal; and
provide at least part of the financial incentive to the leader for meeting, at least in part, the goal.

8. The computer readable medium of claim 7, wherein the campaign is initiated by the sponsor and wherein the user that creates the goal is the sponsor.

9. The computer readable medium of claim 8, further including enabling the first sponsor to recruit a second sponsor to offer the financial incentive to the leader.

10. The computer readable medium of claim 7, wherein the campaign is initiated by the leader and wherein the user that creates the goal is the leader.

11. The computer readable medium of claim 10, wherein multiple leaders are offered the financial incentive in exchange for meeting, at least in part, the goal.

12. The computer readable medium of claim 11, wherein each leader must successfully complete the campaign for any leader to receive any portion of the financial incentive.

13. A computing device for incenting behavior through a campaign, the method comprising:
enabling a user to create a goal;
enabling a first sponsor to offer a financial incentive to a leader in exchange for meeting, at least in part, the goal; and
providing at least part of the financial incentive to the leader for meeting, at least in part, the goal.

14. The computing device of claim 13, wherein the campaign is initiated by the sponsor and wherein the user that creates the goal is the sponsor.

15. The computing device of claim 14, further including enabling the first sponsor to recruit a second sponsor to offer the financial incentive to the leader.

16. The computing device of claim 13, wherein the campaign is initiated by the leader and wherein the user that creates the goal is the leader.

17. The computing device of claim 16, wherein multiple leaders are offered the financial incentive in exchange for meeting, at least in part, the goal.

18. The computing device of claim 18, wherein each leader must successfully complete the campaign for any leader to receive any portion of the financial incentive.
